(19) United States
(12) Patent Application Publication
(10) Pub. No.: US 2005/0082325 A1
(43) Pub. Date: Apr. 21, 2005

(54) Kayak carrier for vehicle roof rack

(76) Inventor: Grayson Bourne, Pelham, NY (US)

Correspondence Address: Donald W. Meeker;Patent Agent, #E, 924 East Ocean Front, Newport Beach, CA, 92661, US

(21) Appl. No.: 11/006,047

(22) Filed: Dec. 7, 2004

Related U.S. Application Data
(63) Continuation-in-part of application No. 10/683,368, filed on Oct. 9, 2003.

(51) Int. Cl. B60R 9/00; B60R 9/042

(52) U.S. Cl. 224/319

(57) ABSTRACT

A pair of padded rigid-V one-piece kayak carrier cradles have integral channel mounts for adjustable mounting on the cross arms of an existing roof rack. An elasticized cord loop stretches over the ends of each of the cradles and under externally protruding pegs. A telescoping or non-telescoping connecting bar may interconnect the two cradles with sliding mating channel connectors to attach the connecting bar to the cross arms of the roof rack.

### REFERENCE TO RELATED PATENT APPLICATION

This is a continuation-in-part of patent application Ser. No. 10/683,368, filed Oct. 29, 2003.

### BACKGROUND OF THE INVENTION

1. Field of the Invention

The present invention relates to the field of kayak carriers that mount on a vehicle rooftop, and particularly to a pair of padded rigid-V one-piece kayak carrier supports that mount on an existing roof rack.

2. Description of the Prior Art

It is often a headache to transport racing and sea kayaks. Loading them onto a vehicle generally includes messing with straps and boat damage. Arrangements are previously known in the art for transporting kayaks and similar craft, these arrangements have obliquely directed support portions which are secured on the load carrier beam so that a craft resting thereon is prevented from being displaced in a lateral direction. Clamping straps are also employed that extend about the load carrier beam for lashing the craft in position.

Most prior art devices provide boat supports which are adjustable in the width of the cradle supporting the boats to accommodate various types and sizes of boats. These prior art boat supports lack a rigid structure and rigid means of securing to a roof rack. The separate parts screwed together for adjustment rely on the skill and strength of the user to insure a solid cradle and solid connection of the cradle to the roof rack. Due to the very high wind lift forces encountered in high-speed highway driving, boats may be lifted from a roof rack support which is not rigidly secured.

Prior art. U.S. Pat. No. 4,081,118, issued Mar. 28, 1978 to Mason, provides a carrier for use in supporting, for example, a canoe on a vehicle roof has a base which is adapted for clamping the carrier onto a roof rack which is to be mounted on the vehicle, and a pair of laterally spaced limbs which extend upwardly from the base and define a cradle for supporting the canoe. The limbs are preferably laterally adjustable for altering the width of the cradle. Usually a pair of the carriers will be mounted on the roof rack for supporting the canoe at spaced positions along its length.

Prior art U.S. Pat. No. 5,957,350, issued Sep. 28, 1999 to Giles, puts forth a kayak loading device that employs guiding rollers and roof rack attachment mechanism. The device allows one person to easily and conveniently load a kayak or similar article onto an automobile's roof rack. The device comprises several freely rotating rollers oriented in a “V” configuration by rigid struts attached to a crossmember. Padded feet flexibly mounted to vertical stanchions extending downward from the crossmember support the rear most portion of the loading device. An attachment mechanism extends forward from the crossmember, which securely latches the loading device onto a vehicle's roof rack crossbar. Loading a kayak requires first positioning a kayak's bow into the vertex of the rollers. The stem of the kayak is then pushed upwardly and forwardly along the rollers onto the automobile's roof rack. The device is removed from the automobile's roof rack after the kayak is loaded.

Prior art U.S. Pat. No. 4,239,137, issued Dec. 16, 1980 to Arcouette, shows a carrier and stand device for a boat, such as a canoe, and, in particular, a kayak, which is characterized by its structural advantages as well as for its versatility for use during any phase of the boat life from production to the user, including transportation, storage and display. This device includes a pair of transverse U-shape frames and connector rods allowing to disconnect the pair of frames and compactly store away the components during non-use. The frames are provided with sets of sockets and projections allowing positive stacking of a plurality of such devices in a number of different ways for convenience in storage and display.

Prior art U.S. Pat. No. 5,516,017, issued May 14, 1996 to Arvidsson, describes an arrangement for carrying a craft such as a kayak or a surfboard. The arrangement includes a carrier bar that extends across a vehicle roof, which is fastened to opposite edge portions thereof. Holders are provided for engagement with the carrier bars. The holders are provided with arrangements for fixing the holders in selected positions along the carrier bars. Support members for the craft are made from a flexible material and are fastened to the holders pivotally about axes extending lengthwise of the vehicle. At least two arms are provided with each arm being fastened at a first end thereof to each holder and being pivotable about a pivot axis extending lengthwise of the vehicle. The arms have their free ends connected to the support member pivotally above an axis extending lengthwise of the vehicle such that pivoting of the arms adjusts the shape and position of the support members for a particular craft to be carried.

Prior art U.S. Pat. No. 5,775,557, issued Jul. 7, 1998 to Arvidsson, discloses an arrangement for carrying a craft such as a kayak or a surfboard. The arrangement includes a carrier bar that extends across a vehicle roof, which is fastened to opposite edge portions thereof. Holders are provided for engagement with the carrier bars. The holders are provided with arrangements for fixing the holders in selected positions along the carrier bars. Support members for the craft are made from a flexible material and are fastened to the holders pivotally about axes extending lengthwise of the vehicle. At least two arms are provided with each arm being fastened at a first end thereof to each holder and being pivotable about a pivot axis extending lengthwise of the vehicle. The arms have their free ends connected to the support member pivotally above an axis extending lengthwise of the vehicle such that pivoting of the arms adjusts the shape and position of the support members for a particular craft to be carried.

Prior art U.S. Pat. No. 6,164,507, issued Dec. 26, 2000 to Dean, depicts a boat rack apparatus for carrying a boat on a vehicle roof rack, which has a selectively engageable gripping surface. The apparatus includes one or more mounts configured for attachment adjacent a vehicle. Each mount includes a support region that has a support surface constructed to slidably receive and support a boat above a vehicle roof, and a gripping pad that is movable from a recessed position to a protruding position to restrain the boat from sliding across the support surface. A securing strap is positionable over at least a portion of the boat and configured to hold the boat against the support regions when the strap is tightened. The securing strap passes around the gripping pad to move the pad to the protruding position and press it into contact with the boat. One or more connectors are optionally provided to attach the mounts to roof rack or boat trailer. The securing strap includes a lever-actuated buckle to join opposite ends of the securing strap. A buckle protective housing is optionally provided to protect the boat from damage by the buckle. The buckle housing includes an access hole adjacent the buckle lever. The access hole extends through at least a portion of a top and side surface of the housing to allow a user to operate the lever.

What is needed is a pre-sized rigid-V one-piece rigid padded cradle to receive the kayak instantly by placing it between a pair of the cradles with each cradle having a built-in pre-sized channel mount for a precise fit to a roof rack connecting bar with each cradle having protruding top outside pegs so that an elasticized cord loop can be instantly hooked over the kayak and under the pegs on each cradle.

### SUMMARY OF THE INVENTION

An object of the present invention is to provide a pre-sized rigid-V one-piece rigid padded cradle to receive the kayak instantly by placing it between a pair of the cradles with each cradle having a built-in pre-sized channel mount for a precise fit to a roof rack connecting bar with each cradle having protruding top outside pegs so that an elasticized cord loop can be instantly hooked over the kayak and onto the cradle ends under the pegs.

Another object of the present invention is to provide a pair of aligned padded rigid-V cradles which are presized for the kayak for exact fit so that the kayak need only be positioned between the cradles and tied down with elasticized cord loops which attach instantly under the outside protruding peg at the end of each side of each cradle to eliminate the headache of racing and sea kayak transport. The tie-down system eliminates messing with straps and boat damage by providing simple kayak slide-in and stretch over loop fastening, which system offers ten-second tie-down and security for even the bumpiest rides.

One more object of the present invention is to provide a kayak carrier that has a pre-sized channel mount for a precise fit to an existing roof rack, thereby saving money for the user who has interests in several sports which require roof rack to transport their equipment.

An additional object of the present invention is to provide an alternate embodiment of the invention in which the pair of cradles are each rigidly pre-attached to a telescopically adjustable connecting bar located between the cradles so that the spacing between cradles is adjustable to support the kayak at the correct point and to allow any length boat to be supported by the cradles.

One more additional object of the present invention is to provide slidable U-shaped brackets for mounting the pair of cradles adjustably at any location along a connecting bar to which the cradles are attached and U-shaped brackets for mounting the cradle connecting bar at any location across the width of a roof rack.

In brief, a pair of rigid-V one-piece pre-shaped kayak support cradles, are each mounted to one of a pair of roof rack cross bars and aligned to receive a kayak resting between the cradles. Each cradle has a built-in pre-sized channel mount for a precise fit to an existing roof rack cross bar. The kayak may be received instantly by placing it between the pair of the cradles. Each cradle has protruding top outside pegs so that an elasticized cord loop can be instantly stretched between the ends of the cradle under the pegs and over the kayak, thereby securing the kayak.

An alternate embodiment of the invention is provided in which the pair of cradles are each rigidly pre-attached to a connecting bar between the cradles, which connecting bar may be a telescoping rigid bar to adjust the spacing between the pair of cradles.

Another alternate embodiment of the invention has a slidable U-shaped bracket mount for each of the rigid-V support cradles which are adjustably mounted at any desired positions along a connecting bar to which both support cradles are attached.

The connecting bar may have a pair of slidable U-shaped brackets for mounting the connecting bar to an existing roof rack at any desired point across the width of the roof rack.

An advantage of the present invention is that it eliminates the headache of racing and sea kayak transport by using a pre-sized padded cradle with an instantly stretched and secured elastic cord loop so that there is no more messing with straps, no more boat damage, just a simple slide-in and elastic cord loop fastening system offering ten-second tie-down and security for even the bumpiest rides.

Another advantage of the present invention is that it accommodates all standard racing kayaks and most sea kayaks.

A further advantage of the present invention is that it provides greater longitudinal stability—a must for longer kayaks—no bounce and need to tie down boat ends.

A corollary advantage of the present invention is that it provides improved hull support, reducing point pressure on delicate hulls and seams.

One more advantage of the present invention is that it provides ease of loading by a single person since one end can be loaded at a time.

Yet another advantage of the present invention is that it provides a ten second elastic cord loop securing system.

An additional advantage of the present invention is that it causes less damage to the kayaks by using elastic cord loops than harsh fabric straps.

Still another advantage of the present invention is that it is compatible with commonly used cross bar roof racks.

A longevity advantage of the present invention is that it provides a sleek, non-rust powder coat impact resistant finish for long term durability.

One additional advantage of the present invention is that it provides a model for virtually every kayak available.

A still further advantage of the present invention is that it provides a longer version structured to accommodate slightly wider boats, racing kayaks, or single rowing sculls.

Still one more advantage of the present invention is that it provides an 8-foot brace or connecting bar between cradles which gives greater longitudinal support and can accommodate wider kayaks (up to 17″ at 8′ span).

An advantage to an alternate embodiment of the present invention is that it provides an adjustable length connecting bar between cradles to accommodate kayaks of a variety of lengths.

One more advantage of the present invention is that slidable U-shaped brackets can be provided for both the cradles and the connecting bar to allow the cradles to be adjustably mounted at any desired points along the length of the connecting bar supporting the cradles and allow the connecting bar to be adjustably mounted at any desired location across the width of a roof rack.

Another advantage of the present invention is that it may be used with an existing roof rack with channel mounts pre-sized to fit the roof rack for a tight secure fit.

A further advantage of the present invention is that it is lightweight and easy to install.

Yet another advantage of the present invention is that it is inexpensive to manufacture.

Still another advantage of the present invention is that it offers a simple fastening system.

One more advantage of the present invention is that the kayak is very secure when tied down.

### BRIEF DESCRIPTION OF THE DRAWINGS

These and other details of my invention will be described in connection with the accompanying drawings, which are furnished only by way of illustration and not in limitation of the invention, and in which drawings:

FIG. 1 is a perspective view of a pair of the rigid-V one-piece pre-shaped kayak support cradles of the invention, each mounted to one of a pair of roof rack cross bars and aligned to receive a kayak resting between the cradles;

FIG. 2 is an end elevational view of one of the kayak support cradles of FIG. 1 shown supporting one end of a kayak with an elasticized cord loop stretched over the kayak and hooked under the protruding pegs on the outside top of each side of the cradle;

FIG. 3 is a side elevational view of a vehicle having each of the two cradles of FIG. 1 mounted on one of a pair of roof racks supporting a kayak between the two cradles with an elasticized cord loop stretched over the kayak and hooked under the pegs on each cradle to hold down the kayak;

FIG. 4 is a perspective view an alternate embodiment of the pair of cradles each rigidly pre-attached to a telescoping connecting bar between the cradles;

FIG. 5 is a perspective view of an alternate embodiment of a rigid-V cradle with a slidable square U-shaped bracket and attaching plate for mounting the cradle adjustably along a length of a connecting bar supporting the cradle;

FIG. 6 is a front elevational view of the cradle of FIG. 6 showing the connecting bar to which the cradle is mounted and a kayak resting on the cradle with the bungee cords stretched between the arms of the cradle over the kayak;

FIG. 7 is a perspective view of a pair of the cradles of FIG. 6 mounted on a connecting bar with slidable square U-shaped brackets and the connecting bar slidably mounted with slidable square U-shaped brackets on a pair of roof rack supports;

FIG. 8 is a perspective view of a pair of the cradles rigidly built into the ends of a length adjustable telescoping connecting bar and the connecting bar slidably mounted on a pair of roof rack supports with slidable square U-shaped brackets;

FIG. 9 is a side elevational view of a vehicle with the two cradles rigidly attached to the telescoping connecting bar of FIG. 4 and FIG. 8 mounted on a pair of roof racks supporting a kayak between the two cradles with an elasticized cord loop stretched over the kayak and hooked under the pegs on each cradle to hold down the kayak.

### BEST MODE FOR CARRYING OUT THE INVENTION

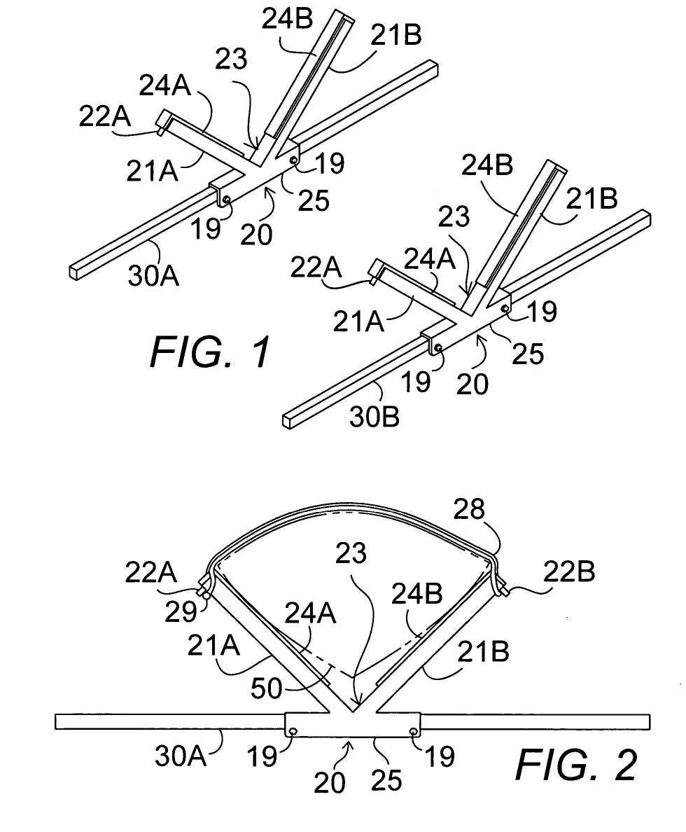

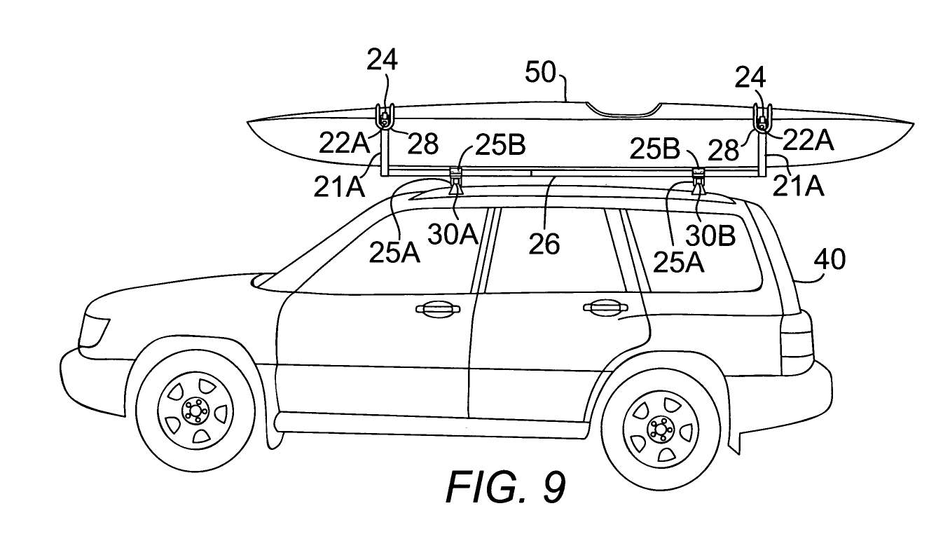

In FIGS. 1-9, a kayak carrier 20 and 20A secures a kayak 50 to a roof rack 30A and 30B of a vehicle 40. The kayak carrier comprises a pair of rigid V-shaped one-piece cradles 23, each of the cradles formed into a rigid one-piece V shape with two arms 21A and 21B permanently interconnected to form the V shape. Each of the cradles is structured to support a hull of any of a variety of types of kayaks 50 within the V shape on the two arms, as seen in FIGS. 2, 3, 6, and 9, so that the pair of cradles are spaced apart and aligned to receive the kayak 50 therebetween. Each of the arms 21A and 21B has a layer of padding 24A and 24B extending over an inside face of each of each of the arms and over a top end of each of the arms. Each of the arms 21A an 21B has a protruding peg 22A and 22B on an outside face of each of the arms adjacent to the top end.

At least one pair of slidable U-shaped mounting elements 18, 18A, and 25 are attachable between the pair of the V-shaped cradles 23 and a roof rack bar 30A an 30B on a vehicle 40.

Each of a pair of elasticized cord loops 28 are stretchable with a tight fit over a kayak 50 resting on both of the cradles 23 with each of the elasticized cord loops 28 hooked around one of the pair of cradles 23 between the two arms 21A and 21B with the cord loop 28 hooked under the protruding peg 22A and 22B on each arm.

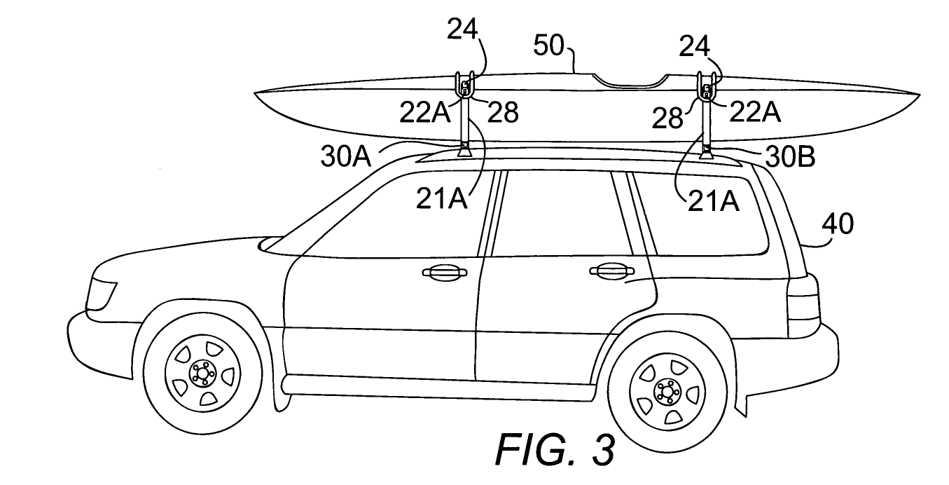

In FIGS. 1-3, a kayak carrier device 20 for securing a kayak 50 to the cross arms 30A and 30B of a roof rack of a vehicle 40, the device 20 comprises a pair of rigid V-shaped one-piece cradles 23. Each of the cradles 23 is formed in a rigid one-piece V shape 23 with two arms 21A and 21B permanently interconnected to form the V shape. Each of the cradles 23 is pre-sized to support a hull of a kayak 50 within the V shape on the two arms 21A and 21B. The two arms 21A and 21B are each rigidly attached with a permanent one-piece connection to a mounting channel 25 at a bottom of the V shape 23. The V-shape 23 and the mounting channel 25 are preferably formed of weatherproof metal welded together to form a single piece 20. The mounting channel 25 is pre-sized and pre-structured to fit with a tight friction fit over a cross arm 30A or 30B of a roof rack, so that the pair of cradles 23 with one on each of the pair of spaced roof racks 30A or 30B may be aligned to receive a kayak 50 therebetween, as shown in FIG. 3. The mounting channels 25 each have a pair of vertical sides of the channel extending below the cross arm and the securing means comprises a pair of bolts 19 secured between the vertical sides below the roof rack cross bar 30A, as shown in FIG. 2.

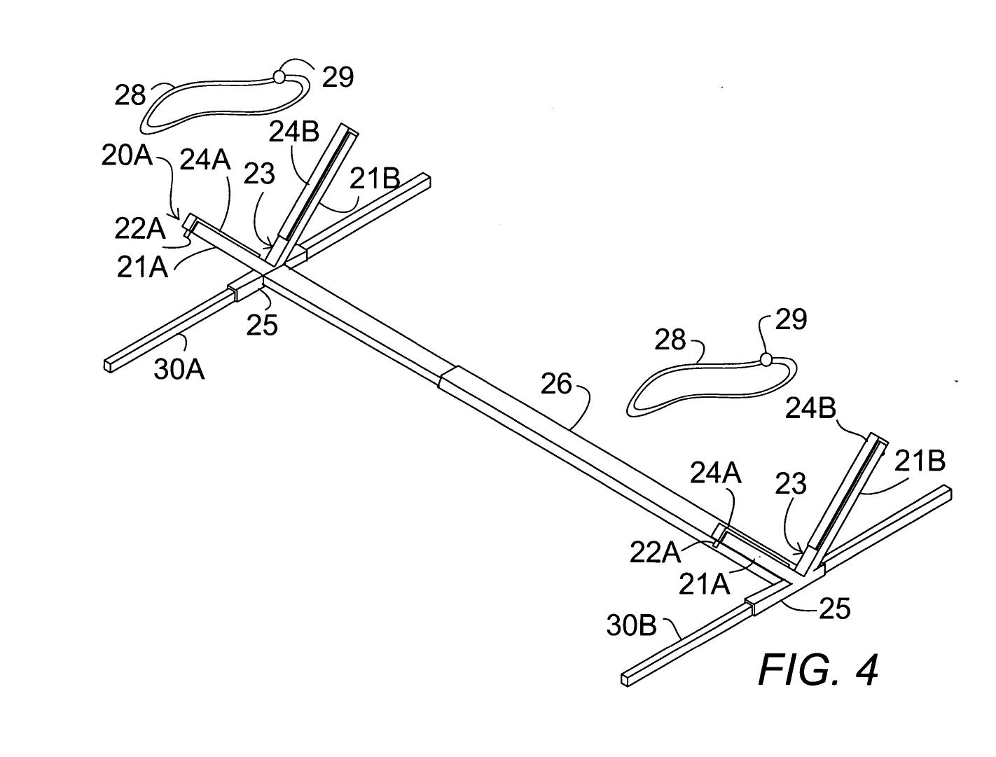

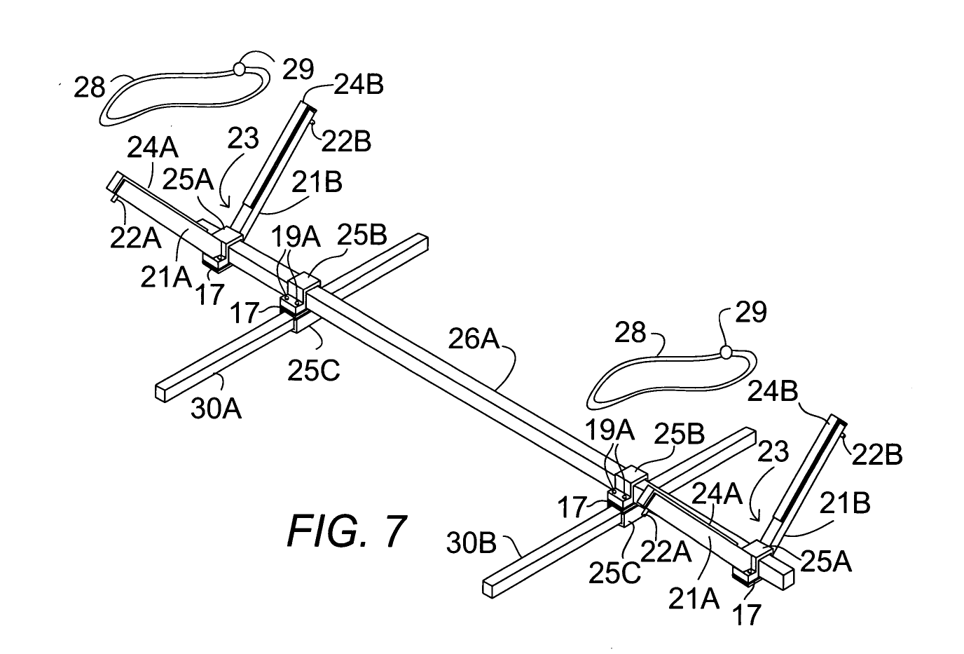

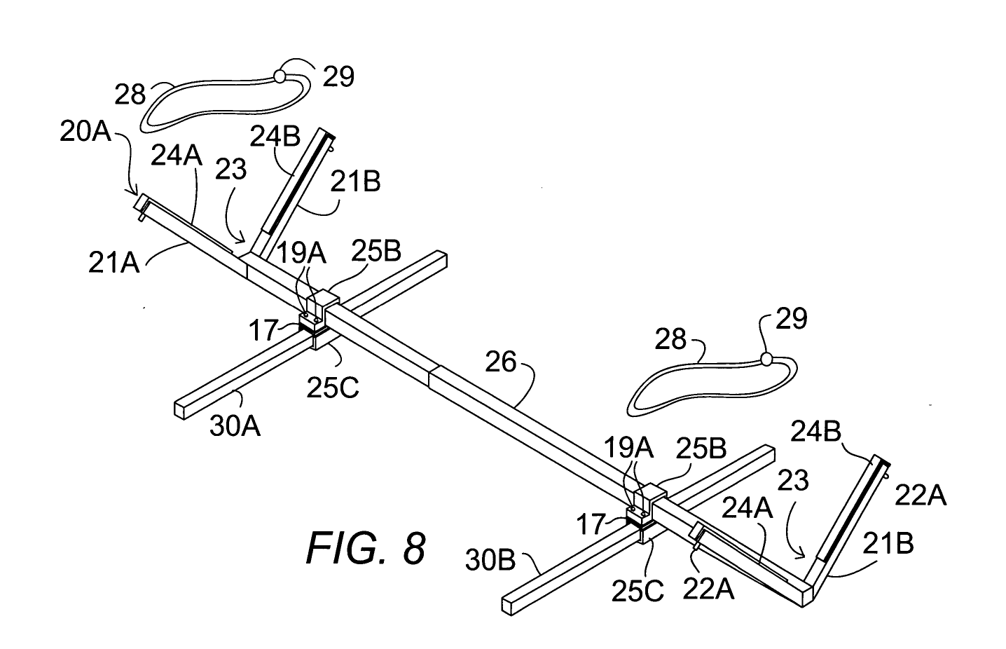

In FIGS. 4, 8, and 9, an alternate kayak carrier 20A may further comprise a rigid telescoping connecting bar 26 adjustably set at a desired length by a screw or pin or other securing means to telescope closed for storage and telescope open to accommodate the length of the kayak, the connecting bar permanently attached between the two cradles 23 with a rigid one-piece connection to each of the cradles 23. In FIG. 7, alternately a rigid non-telescoping connecting bar 26A may support the pair of cradles adjustably mounted on square U-shaped channels 25A. The connecting bar 26 is attached to each of the cross arms 30A and 30B of the roof rack by an inverted channel 25A under each of the cross arms bolted by a pair of bolts 19A to each side of a flanged channel 18 set down over the connecting bar 26 with a plate 17 between the flanged channel 18 and the inverted channel 25A. The double channel attachments can be adjusted to fit any spacing of roof rack cross arms. The connecting bar 26 provides full support for the kayak 50 even on vehicles with small roofs and eliminates the need for tie downs at the ends of the kayak for fast loading and unloading.

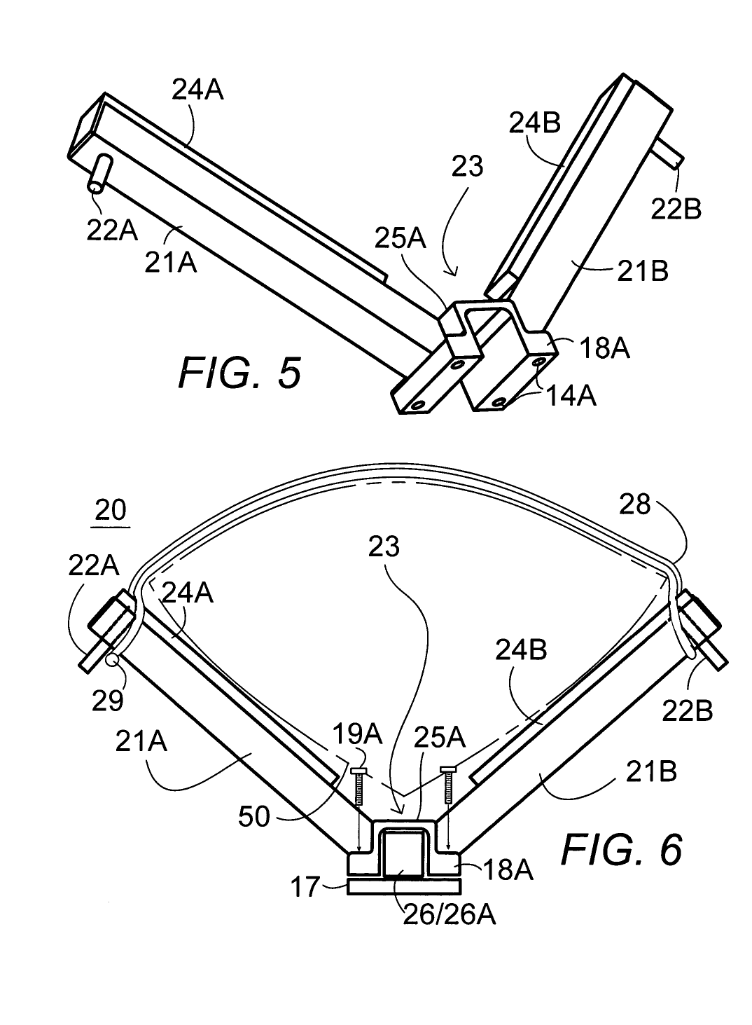

The kayak carrier device 20 and 20A also comprises a pair of elasticized cord loops 28, with each cord 28 having a sphere 29 connector to connect the two ends of the cord together to form the loop. The elasticized cords 28 can stretch with a tight fit over a kayak 50, which rests on both of the cradles 23, as shown in FIGS. 3 and 5. Each of the elasticized cord loops 28 is hooked around one of the arms 21A or 21B of one of the cradles 23 under the protruding peg 22A or 22B, as shown in FIGS. 2, 3 and 5.

In FIGS. 5-9, a preferred embodiment of the kayak carrier 20 has a channel 25A permanently attached to the interconnected arms 21A and 2B of each of the cradles 23 with the channel facing downwardly to fit over one of a connecting bar 26A between the cradles and further comprising an attaching flange 18A extending outwardly from each of the outside corners of the channel and a rigid plate 17 for positioning below the support bar 26 and 26A, the rigid plate 17 mating with the attaching flanges 18 and 18A and the attaching flanges and the mating plate having mating holes therein and the securing means comprises bolts 19A secured through the mating holes.

In practice, the V-shaped cradles 23 of the carrier 20 would be mounted on the existing roof rack cross arms 30A and 30B, one cradle 23 per each cross arm 30A or 30B, with the mounting channels 25 fitting snugly on the cross arms 30A or 30B. The kayak 50 would be positioned in the V-shaped cradles 23 resting on the padding 24A and 24B of both cradles 23, as shown in FIG. 2. The kayak 50 would be secured in place by attaching one end of each of the elasticized cord loops 28 over an end of an arm 21A or 21B of the cradle, such an elasticized cord 28 looped over the peg 22A of the first arm 21A of the cradle 23 and then stretching the cord 28 tightly over the kayak 50 and looping the opposite end of the elasticized cord loop 28 over the second arm 21B of the cradle 23 with the loop under the protruding peg 22B. The kayak 50 would be secured in this manner on both cradles 23, as shown in FIG. 3.

In practice, the length of the crossbar 26 of the alternate embodiment 20A would be adjusted by moving its two telescoping sections to accommodate the length of the kayak and the mounting channels 25A attached to the roof rack cross arms 30A and 30B. The kayak 50 would be placed onto the V-shaped cradles 23 resting on the padding 24A and 24B. The kayak 50 would be secured in place by attaching one end of an elasticized cord 28 over the peg 22A of the first arm 21A of the cradle 23 and then stretching the cord 28 tightly over the kayak 50 and attaching the end of the cord 28 around the second arm 21B of the cradle under the protruding peg 22B. The kayak would be secured in this manner on both cradles, as shown in FIG. 5.

The present invention comprises non-rusting lightweight aluminum kayak carriers with all stainless steel bolts.

It is understood that the preceding description is given merely by way of illustration and not in limitation of the invention and that various modifications may be made thereto without departing from the spirit of the invention as claimed.

1. A kayak carrier for securing a kayak to a roof rack of a vehicle, the kayak carrier comprising:
a pair of rigid V-shaped one-piece cradles, each of the cradles formed into a rigid one-piece V shape with two arms permanently interconnected to form the V shape, each of the cradles structured to support a hull of any of a variety of types of kayaks within the V shape on the two arms, so that the pair of cradles are spaced apart and aligned to receive a kayak therebetween, each of the arms having a layer of padding extending over an inside face of each of each of the arms and over a top end of each of the arms, each of the arms having a protruding peg on an outside face of each of the arms adjacent to the top end,
at least one pair of slidable U-shaped mounting elements attachable between the pair of the V-shaped cradles and a roof rack on a vehicle;
a pair of elasticized cord loops, each of the elasticized cord loops stretchable with a tight fit over a kayak resting on both of the cradles with each of the elasticized cord loops hooked around one of the pair of cradles between the two arms with the cord loop hooked under the protruding peg.

2. The kayak carrier of claim 1 wherein the at least one pair of slidable U-shaped mounting elements are each rigidly attached with a permanent connection to one of the cradles, each of the mounting elements comprising a downwardly open channel pre-sized and pre-structured to fit with a tight friction fit and secured by a securing means to one of a pair of spaced cross arms of a vehicle roof rack.

3. The kayak carrier of claim 2 wherein the channel is permanently attached to the interconnected arms of each of the cradles with the channel facing downwardly to fit over one of the cross arms of the roof rack and further comprising a pair of vertical sides of the channel extending below the cross arm and the securing means comprises a pair of bolts secured between the vertical sides below the cross arm to form the mounting element.

4. The kayak carrier of claim 3 wherein the arms and the mounting channel are formed of metal welded together to form a single piece.

5. The kayak carrier of claim 2 wherein the channel is permanently attached to the interconnected arms of each of the cradles with the channel facing downwardly to fit over one of the cross arms of the roof rack and further comprising an attaching flange extending outwardly from each of the outside corners of the channel and a rigid plate for positioning below the channel, the rigid plate mating with the attaching flanges and the attaching flanges and the mating plate having mating holes therein and the securing means comprises bolts secured through the mating holes.

6. The kayak carrier of claim 1 further comprising a rigid connecting bar permanently attached between the two cradles with a rigid one-piece connection to each of the cradles.

7. The kayak carrier of claim 6 wherein the rigid connecting bar is formed in at least two telescoping sections secured together by a screw means to make the connecting bar collapsible and expandable and adjustable in length.

8. The kayak carrier of claim 6 wherein the at least one pair of slidable U-shaped mounting elements comprises a pair of U-shaped channels adjustably mounted on the connecting bar with channel openings facing downwardly with the channels straddling the connecting bar and a mating pair of U-shaped channels facing upwardly one fitting under each of two cross arms of a vehicle roof rack, and the securing means comprises threaded connector means interconnecting the pairs of channels.

9. The kayak carrier of claim 1 further comprising a rigid connecting bar slidably attachable between the two cradles and the at least one pair of slidable U-shaped mounting elements comprising a pair of slidable U-shaped mounting elements each rigidly attached with a permanent connection to one of the cradles, each of the mounting elements comprising a downwardly open channel pre-sized and pre-structured to fit with a slidable fit over the rigid connecting bar and further comprising a second pair of U-shaped channels slidably mounted on the connecting bar with channel openings facing downwardly with the, channels straddling the connecting bar and a mating pair of U-shaped channels facing upwardly one fitting under each of two cross arms of a vehicle roof rack, and the securing means comprises threaded connector means interconnecting the pairs of channels.
